(19) United States
(12) Patent Application Publication
(10) Pub. No.: US 2019/0337051 A1
(43) Pub. Date: Nov. 7, 2019

(54) HOT-DEFORMED MAGNET, METHOD FOR PRODUCING RAW MATERIAL POWDER FOR HOT-DEFORMED MAGNET, AND METHOD FOR PRODUCING HOT-DEFORMED MAGNET

(71) Applicant: HONDA MOTOR CO., LTD, Tokyo (JP)

(72) Inventors: Yoshiyuki Nakazawa, Wako-shi (JP); Ryutaro Kato, Wako-shi (JP); Yasutaka Shintani, Wako-shi (JP); Haruhiko Shimizu, Wako-shi (JP); Takeshi Okuno, Wako-shi (JP)

(73) Assignee: HONDA MOTOR CO., LTD, Tokyo (JP)

(21) Appl. No.: 16/405,112

(22) Filed: May 7, 2019

(30) Foreign Application Priority Data
May 7, 2018 (JP) 2018-089083

(51) Int. Cl. B22F 1/00; C22C 38/10; C22C 38/00; B22F 9/04; B22F 3/14; H01F 1/057; H01F 41/02

(52) U.S. Cl. CPC B22F 1/0085; C22C 38/10; C22C 38/005; C22C 38/002; B22F 9/04; B22F 2301/355; H01F 1/0576; H01F 41/0266; C22C 2202/02; B22F 2009/048; B22F 3/14

(57) ABSTRACT

A hot-deformed magnet is obtained by quenching and solidifying a melt of an alloy containing a rare earth element (RE), Fe, and B as main components by a super quenching method using a rotating roll; preparing an alloy powder in an amorphous structure state or an amorphous-microcrystalline mixed structure state; subjecting the alloy powder to a rapid heat treatment in a falling-type heating furnace so as to obtain a raw material powder; hot-forming the raw material powder so as to densify the raw material powder to near true density and form a hot-formed compact; and subjecting the hot-formed compact to uniaxial hot plastic working to orient crystals.

### CROSS REFERENCES TO RELATED APPLICATIONS

The present application claims priority under 35 U.S.C. § 119 to Japanese Patent Application No. 2018-089083, filed May 7, 2018, entitled “Hot-deformed magnet, Method For Producing Raw Material Powder For Hot-deformed magnet, And Method For Producing Hot-deformed magnet.” The contents of this application are incorporated herein by reference in their entirety.

### TECHNICAL FIELD

The present disclosure relates to, for example, a hot-deformed magnet, a method for producing a raw material powder for a hot-deformed magnet, and a method for producing a hot-deformed magnet. In particular, the present disclosure relates to a technique for obtaining fine, even crystal grains with few coarse grains.

### BACKGROUND

Japanese Unexamined Patent Application Publication Nos. 60-100402, 2001-155913, and 2012-244111 disclose examples of hot-deformed magnets. For example, the hot-deformed magnet described in Japanese Unexamined Patent Application Publication No. 60-100402 is obtained by quenching and solidifying a melt of a RE-Fe—B-based alloy (RE represents a rare earth element) and pressurizing the amorphous or microcrystalline solid material at a high temperature to orient crystals. This production method is called a hot plastic working method and is considered as a technique comparable to a sintering method.

Compared to the sintering method, which is a common method for producing rare earth permanent magnets, the hot plastic working method is capable of decreasing the crystal grain size, and thus can increase the coercive force without using rare and expensive materials such as dysprosium (Dy). However, whereas crystals are oriented by applying an external magnetic field to the raw material powder in the sintering method, crystals are oriented by utilizing crystal rotation and crystal anisotropic growth in the hot plastic working method. Since it is difficult to achieve high orientation and the magnetic properties are thereby poor according to the hot plastic working method, its practical application has been stalling.

As mentioned above, crystals are oriented by utilizing crystal rotation and crystal anisotropic growth in the hot plastic working method, and it is known that, in order to orient crystals, hot plastic working is performed at a temperature of about 600° C. to 800° C. Since the ease of orientation depends on the anisotropy of the crystal grains, high orientation tends to be achieved by performing hot plastic working at a higher temperature side; however, large crystal grains that grow at high temperatures lower the coercive force. Furthermore, when the crystal grains become excessively coarse, adjacent crystal grains block one another, and crystal rotation is thereby inhibited.

The raw material powder for a hot-deformed magnet is typically produced by a liquid quenching method such as a melt spinning method or an atomizing method, a hydrogenation decomposition desorption recombination method (HDDR), or the like. This raw material powder is densified to form a compact and then subjected to hot plastic working; however, since the temperature for the hot plastic working is relatively lower than the sintering temperature in the sintering method, a homogeneous structure is difficult to obtain. In particular, crystal grain coarsening attributable to the state of the structure of the raw material powder readily occurs at the boundaries of the raw material powder of the hot-deformed magnet. The coarse crystal grains present in the boundaries of the raw material powder do not rotate as smoothly as the crystal grains in normal regions, are thus difficult to orient highly, and may remain isotropic even after the hot plastic working. Moreover, depending on the state of the raw material powder, columnar crystals oriented in a direction orthogonal to the crystal orientation direction, which is the hot plastic working direction, may occur. These coarse crystal grains significantly degrade magnetic properties.

### SUMMARY

For example, the present application describes a hot-deformed magnet that has excellent magnetic properties and that can achieve high orientation by having fine crystal grains with few coarse grains, a method for producing a raw material powder for a hot-deformed magnet, and a method for producing a hot-deformed magnet.

An aspect of the present disclosure provides a method for producing a raw material powder for a hot-deformed magnet, the method including quenching and solidifying a melt of an alloy containing a rare earth element (RE), Fe, and B as main components by a super quenching method using a rotating roll; preparing an alloy powder in an amorphous structure state or an amorphous-microcrystalline mixed structure state; and subjecting the alloy powder to a rapid heat treatment in a falling-type heating furnace so as to obtain a raw material powder.

In the above-described method of the present disclosure, when rapid heating is conducted to a temperature equal to or higher than the crystallization onset temperature at a temperature elevation rate of 400° C./minute or more, the nucleation driving force is high, nucleation occurs at once, and a fine structure can be obtained. Thus, the temperature elevation rate during the rapid heat treatment in the falling-type heating furnace is preferably 400° C./minute or more. Here, the crystallization onset temperature is dependent on the alloy components. In the present disclosure, the heating temperature during rapid heating is preferably within the temperature range of 600° C. to 800° C. When the heating temperature is below 600° C., crystallization is insufficient. When the heating temperature exceeds 800° C., coarse crystals occur.

The temperature elevation rate for rapid heating is preferably as high as possible. The free-fall heating using the falling-type heating furnace according to the present disclosure is preferable since a temperature elevation rate of 1000° C./minute or more or 5000° C./minute or more can be achieved. The atmosphere inside the falling-type heating furnace is preferably a vacuum or an inert gas atmosphere such as argon or helium. In the present disclosure, the number of times rapid heating is conducted is not limited to one. Rapid heating may be performed twice or more under the same or different conditions within the ranges of the rapid heating conditions described above. The oxygen concentration in the interior of the falling-type heating furnace during rapid heating is preferably 300 ppm or less.

In the method for producing a raw material powder for a hot-deformed magnet according to the above-described aspect, a heating zone of the falling-type heating furnace may have a length of 0.5 m or more, and a furnace core into which the alloy powder falls may extend substantially in a vertical direction or is slanted within 5° with respect to the vertical direction.

In the method for producing a raw material powder for a hot-deformed magnet according to the above-described aspect, 50% or more of the raw material powder after the rapid heat treatment may be crystallized, and an oxygen concentration of the raw material powder or an oxygen concentration of a hot-deformed magnet produced by using the raw material powder may be 3000 ppm or less.

In the method for producing a raw material powder for a hot-deformed magnet according to the above-described aspect, the alloy containing a rare earth element (RE), Fe, and B as main components may be represented by a compositional formula, REₓ(Fe, Co)₁₀₀₋ₓB_{y}M_{z}, where: RE represents a rare earth element that contains 90 atom % or more of one or both of Pr and Nd, and 0 atom % or more and 10 atom % or less of at least one element selected from Y and lanthanoid series elements other than Pr and Nd; M represents at least one element selected from the group consisting of Al, Si, Ti, V, Cr, Mn, Ni, Cu, Ga, Zr, Nb, Mo, Hf, Ta, W, Pt, Pb, Au, and Ag; and compositional ratios x, y, and z satisfy 12≤x≤16, 4≤y≤7, and 0.01≤z≤5.

Another aspect of the present disclosure provides a method for producing a hot-deformed magnet, the method including hot-forming the raw material powder obtained by the method described above so as to densify the raw material powder to near true density and form a hot-formed compact; and subjecting the hot-formed compact to uniaxial hot plastic working to orient crystals. The temperature during the hot plastic working is a temperature equal to or higher than the melting point of the crystal grain boundaries and is also a temperature that promotes deformation. The technique of the hot plastic working may be forging, upsetting, extruding, or any other desired technique.

Another aspect of the present disclosure provides a hot-deformed magnet produced by the method described above. In this hot-deformed magnet, coarse crystal grains having a crystal grain size of 0.5 μm or more may be present at an area ratio of 10% or less. Furthermore, even when Dy or Tb is not contained, the product of a residual magnetic flux density (kG) and a coercive force (kOe) may be 250 or more.

### BRIEF DESCRIPTION OF THE DRAWINGS

The advantages of the disclosure will become apparent in the following description taken in conjunction with the following drawings.

FIGS. 1A to 1D are diagrams illustrating one embodiment of a method for producing a hot-deformed magnet according to the present disclosure.

FIG. 2 is a side view illustrating an internal structure of a recovery box of a falling-type heating furnace used in this embodiment.

FIG. 3 is a graph illustrating the relationship between the heating temperature, the powder crystallinity, and the magnetic properties in Example 1.

FIG. 4 is a SEM image of a section of a raw material powder of a comparative example in Experimental Example 1.

FIG. 5 is a SEM image of a section of a raw material powder of an example in Experimental Example 1.

FIG. 6 is a graph illustrating the relationship between the heated length and the magnetic properties obtained in Experimental Example 2.

FIG. 7 is a graph illustrating the relationship between the heated length and the powder crystallinity obtained in Experimental Example 2.

FIG. 8 is a graph illustrating the relationship between the oxygen concentration and the magnetic properties of a hot-deformed magnet obtained in Experimental Example 3.

FIG. 9 is a graph illustrating the relationship between the RE content and the magnetic properties obtained in Experimental Example 4.

### DETAILED DESCRIPTION

### 1. Powder Forming Step

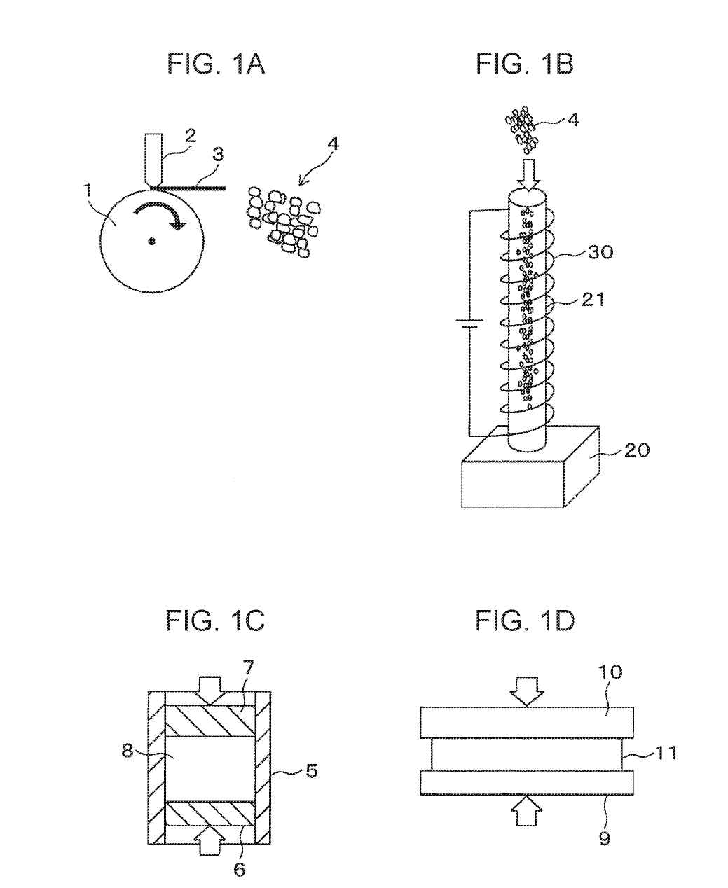

FIGS. 1A to 1D illustrate steps in a method for producing a hot-deformed magnet according to one embodiment. FIG. 1A illustrates an apparatus used to produce an alloy strip by a liquid quenching method. In this step, first, a molten alloy is sprayed together with gas from a nozzle 2 onto a surface of a rotating roll 1, in which cooling water is distributed, so as to instantaneously cool and solidify the molten alloy and produce a strip 3. Due to this quenching, the structure of the strip 3 turns into an amorphous structure or a fine structure having a crystal grain size of several tens of nanometers. Subsequently, the strip 3 is pulverized to prepare a powder 4 of the alloy.

The alloy contains RE-Fe—B as main components (RE represents a rare earth element), and the following alloy is used. The alloy is represented by a compositional formula, REₓ(Fe, Co)₁₀₀₋ₓB_{y}M_{z}, where RE represents a rare earth element that contains 90 atom % or more of one or both of Pr and Nd, and 0 atom % or more and 10 atom % or less of at least one element selected from Y and lanthanoid series elements other than Pr and Nd, M represents at least one element selected from the group consisting of Al, Si, Ti, V, Cr, Mn, Ni, Cu, Ga, Zr, Nb, Mo, Hf, Ta, W, Pt, Pb, Au, and Ag, and compositional ratios x, y, and z satisfy 12≤x≤16, 4≤y≤7, and 0.01≤z≤5.

### 2. Rapid Heating Step

FIG. 1B is a schematic view of a falling-type heating furnace. The falling-type heating furnace includes a recovery box 20, a cylindrical metal tube 21 fixed to an upper surface of the recovery box 20, and a coil heater 30 installed in the metal tube 21 to heat the metal tube 21.

In the rapid heating step, the interior of the metal tube 21 is vacuumed or substituted by an inert atmosphere such as Ar gas, and is heated to 600° C. to 800° C. The powder 4 is injected into the metal tube 21 by using a hopper (not illustrated in the drawings) from an upper end opening of the metal tube 21. The powder 4 is rapidly heated as the powder 4 falls inside the metal tube 21.

The length of the heating zone in which the powder 4 is heated inside the metal tube 21 is at least 0.5 m and is, for example, several meters. In addition, the furnace core inside the metal tube 21 into which the alloy powder falls is installed to extend in a vertical direction or may be slanted within 5° with respect to the vertical direction. The powder 4 falls onto the recovery box 20 by free fall inside the metal tube 21 in, for example, about 5 seconds. The temperature elevation rate of the powder 4 in the metal tube 21 is preferably 400° C./minute or more.

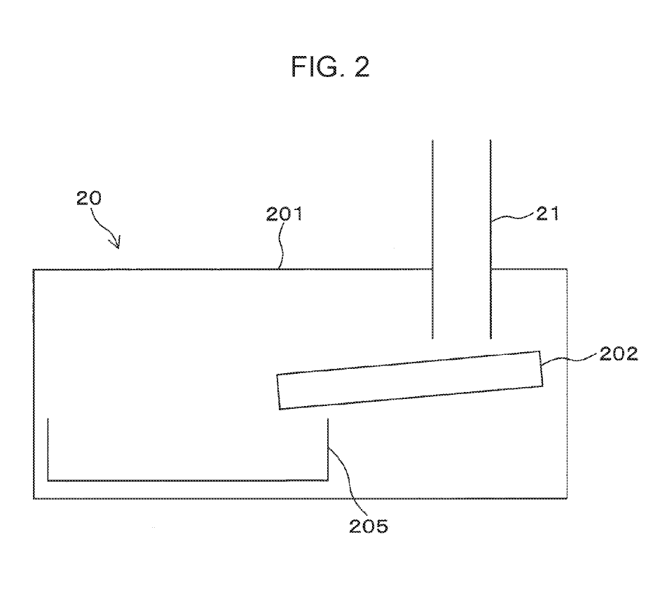

FIG. 2 illustrates the structure inside the recovery box 20. The metal tube 21 has a lower end portion penetrating one end side (right side in FIG. 2) upper portion of an upper plate 201 of the recovery box 20. The powder 4 that has passed through the interior of the metal tube 21 lands on a vibrating feeder 202 and is cooled with water. In addition, a water-cooled recovery vessel 205 is installed on the left side of the vibrating feeder 202 in the drawing. Due to the vibrating feeder 202, the powder 4 landing thereon is transported toward the water-cooled recovery vessel 205 and falls onto the recovery vessel 205. The recovery vessel 205 is water-cooled, and the powder 4 in a cooled state is stored in the recovery vessel 205. The powder 4 rapidly cooled after rapid heating is taken out of the recovery box 20 together with the recovery vessel 205.

### 3. Densifying Step

Next, as illustrated in FIG. 1C, a cavity inside a mold constituted by a die 5, a lower punch 6, and an upper punch 7 is filled with the powder 4, and the powder 4 is compressed by the lower punch 6 and the upper punch 7 to prepare a compact 8. Compression is performed at a temperature of 500° C. to 800° C., and densification is conducted until the porosity is nearly zero, in other words, until the density is close to the true density. Alternatively, the powder 4 may be cold-formed, and the resulting cold-formed compact may be heated to the aforementioned temperature and hot-formed.

### 4. Plastic Working Step

Next, as illustrated in FIG. 1D, the compact 8 is plastic-worked by uniaxially compressing the compact 8 by using a lower mold 9 and an upper mold 10. This plastic working is performed while heating the compact 8 at a temperature of about 700° C. (hot plastic working). When plastic working is performed within this temperature range, crystal grains rotate and become oriented. Specifically, the crystal grains are oriented so that the C axes of the crystal lattice are parallel to the compression axis. As a result, a hot-deformed magnet of this embodiment is obtained.

### EXAMPLES

The present disclosure will now be described in detail through more specific examples.

### 1. Experimental Example 1 (Regarding the Influence of the Heating Temperature)

An alloy ribbon (Nd_{10.5}Pr_{3.6}Fe_{77.4}Co_{2.5}Ga_{0.5}B_{5.6}) prepared by a super quenching method using a rotating roll was roughly pulverized to prepare a raw material powder. A hot-deformed magnet was prepared by hot-forming this raw material powder at 650° C. by using a hot pressing machine until the density was near the true density, and then uniaxially hot-plastic-working the hot-formed compact at 700° C. until the reduction reached 70% (Comparative Example 1). The reduction is defined as follows: (1−height after plastic working/height before plastic working)×100%.

In contrast, a hot-deformed magnet was prepared by subjecting a raw material powder having the composition of Comparative Example 1 above to a rapid heat treatment using the falling-type heating furnace illustrated in FIG. 1B, and then performing the same hot forming and hot plastic working as in Comparative Example 1 above on this raw material powder. In the rapid heat treatment, as indicated in Table 1, the heating temperature of the heater of the falling-type heating furnace was changed (Examples 1 to 7). The heated length (the length of the rapidly heated zone) inside the metal tube of the falling-type heating furnace was set to 5 m.

TABLE 1

| | | Rapid heat treatment | | Powder | | | | | |
|---|---|---|---|---|---|---|---|---|---|
| | | conditions | | crystallinity | Magnetic properties after hot | | | | Coarse |
| | | Heating | Heated | after rapid | deforming | | | | grain |
| | Raw material powder | temperature | length | heating | Br | iHc | Hk/iHc | Br × | area |
| | components | (° C.) | (m) | (%) | (kG) | (kOe) | (%) | iHc | (%) |
| Example 1 | Nd_{10.5}Pr_{3.6}Fe_{77.4}Co_{2.5}Ga_{0.5}B_{5.6} | 500 | 5 | 0 | 12.37 | 20.08 | 79.9 | 248 | 19.5 |
| Example 2 | Nd_{10.5}Pr_{3.6}Fe_{77.4}Co_{2.5}Ga_{0.5}B_{5.6} | 550 | 5 | 3.0 | 12.38 | 20.05 | 85.4 | 248 | 19.4 |
| Example 3 | Nd_{10.5}Pr_{3.6}Fe_{77.4}Co_{2.5}Ga_{0.5}B_{5.6} | 600 | 5 | 52.4 | 12.77 | 19.65 | 88.7 | 251 | 17.2 |
| Example 4 | Nd_{10.5}Pr_{3.6}Fe_{77.4}Co_{2.5}Ga_{0.5}B_{5.6} | 650 | 5 | 99.9 | 13.08 | 21.13 | 90.6 | 276 | 7.3 |
| Example 5 | Nd_{10.5}Pr_{3.6}Fe_{77.4}Co_{2.5}Ga_{0.5}B_{5.6} | 675 | 5 | 100.0 | 13.16 | 21.30 | 91.7 | 280 | 6.5 |
| Example 6 | Nd_{10.5}Pr_{3.6}Fe_{77.4}Co_{2.5}Ga_{0.5}B_{5.6} | 700 | 5 | 100.0 | 13.23 | 21.13 | 92.1 | 280 | 3.9 |
| Example 7 | Nd_{10.5}Pr_{3.6}Fe_{77.4}Co_{2.5}Ga_{0.5}B_{5.6} | 725 | 5 | 100.0 | 13.32 | 20.34 | 84.9 | 271 | 3.4 |
| Comparative | Nd_{10.5}Pr_{3.6}Fe_{77.4}Co_{2.5}Ga_{0.5}B_{5.6} | — | — | 0 | 12.41 | 20.59 | 78.4 | 256 | 19.5 |
| Example 1 | | | | | | | | | |

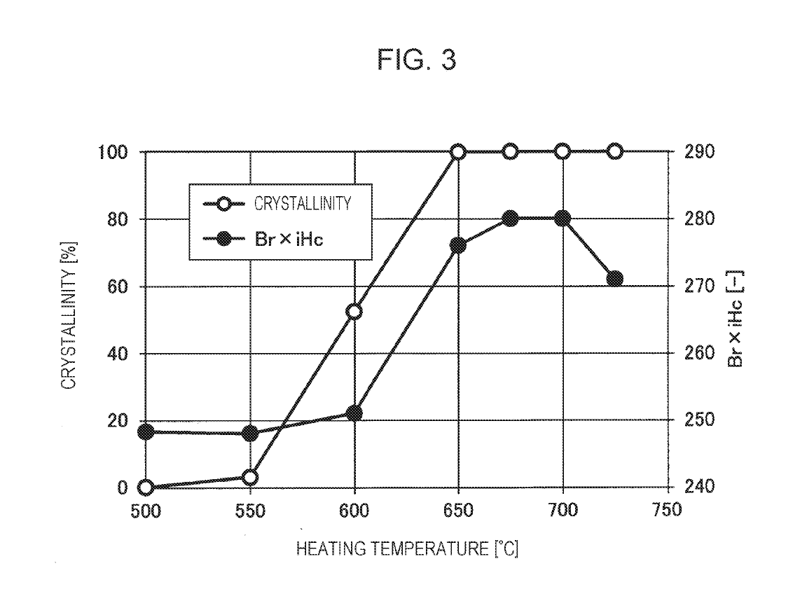

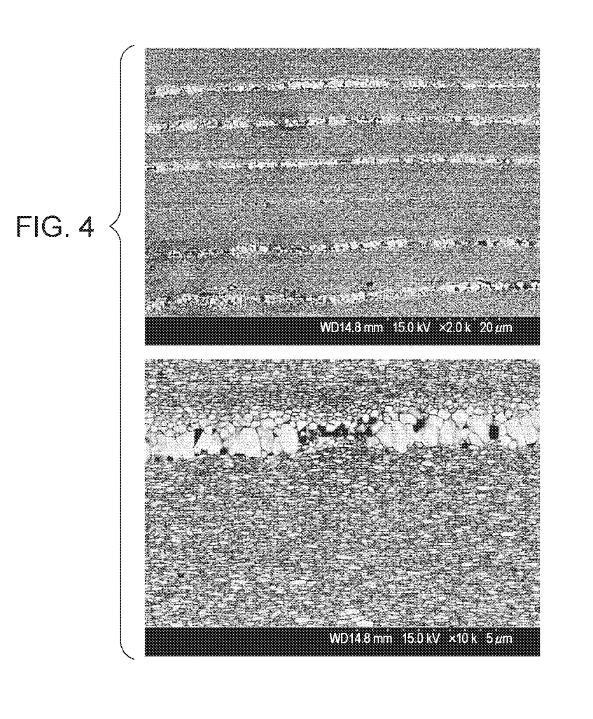

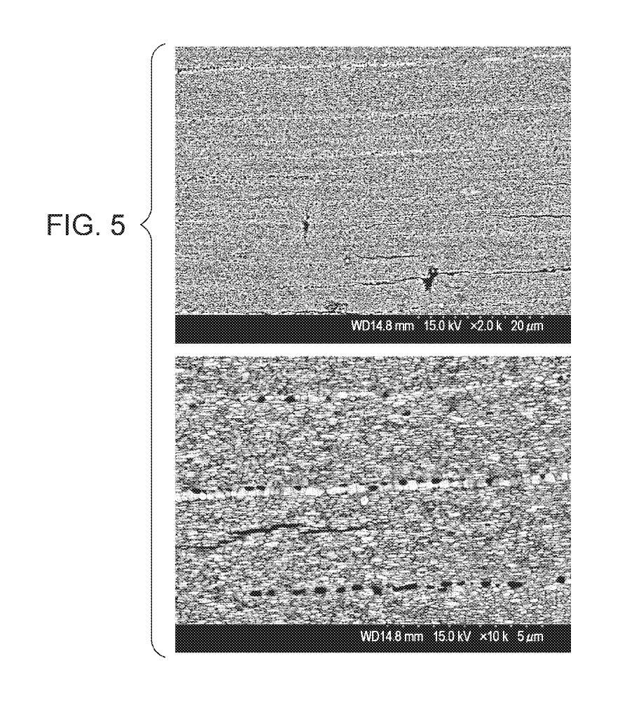

For the hot-deformed magnets of Examples 1 to 7 and Comparative Example 1 prepared as described above, the powder crystallinity defined as the difference in heat of crystallization obtained through a differential scanning calorimetry was investigated. In addition, a superconducting-type vibrating sample magnetometer (VSM-5T produced by Riken Denshi Co., Ltd.) was used to evaluate magnetic properties. Furthermore, a resin-embedded specimen of the hot-deformed magnet was mirror-polished and surface-etched to make the structure prominent, and then the structure was observed by using a FE-SEM (S-4300SE/N produced by Hitachi High-Technologies Corporation). The coarse grain (average grain diameter: 0.5 μm or more) existing area was calculated from the observed structure image by using image analysis software. The results are indicated in Table 1. FIG. 3 illustrates the relationship between the heating temperature, the powder crystallinity, and the magnetic properties, and FIGS. 4 and 5 respectively present structure photographs of Comparative Example 1 and Example 6.

FIG. 3 demonstrates that, compared to Comparative Example 1 that did not undergo the rapid heat treatment, Examples 1 to 7 that underwent the rapid heat treatment exhibited superior magnetic properties, crystallization of the powder progressed at a heating temperature of 600° C. or higher, and the magnetic properties were improved. In addition, as apparent from FIGS. 4 and 5, whereas many coarse crystal grains having a crystal grain size of 0.5 μm or more were found near the raw material powder boundaries in Comparative Example 1, no coarse crystal grains were found in Example 6.

### 2. Experimental Example 2 (Regarding the Influence of the Heated Length)

An alloy ribbon (Nd_{10.5}Pr_{3.5}Fe_{77.2}Co_{2.5}Ga_{0.7}B_{5.6}) prepared by a super quenching method using a rotating roll was roughly pulverized to prepare a raw material powder. A hot-deformed magnet was prepared by hot-forming the raw material powder at 650° C. by using a hot pressing machine until the density was near the true density, and then uniaxially hot-plastic-working the hot-formed compact at 750° C. until the reduction reached 70% (Comparative Example 2).

In contrast, a hot-deformed magnet was prepared by subjecting the raw material powder having the composition of Comparative Example 2 above to a rapid heat treatment using the falling-type heating furnace illustrated in FIG. 1B, and then performing the same hot forming and hot plastic working as in Comparative Example 2 above on this raw material powder. In the rapid heat treatment, as indicated in Table 2, the heating temperature and the heated length of the heater of the falling-type heating furnace were changed (Examples 8 to 22).

TABLE 2

| | | Rapid heat treatment | | Powder | | | | | |
|---|---|---|---|---|---|---|---|---|---|
| | | conditions | | crystallinity | Magnetic properties after hot | | | | Coarse |
| | | Heating | Heated | after rapid | deforming | | | | grain |
| | Raw material powder | temperature | length | heating | Br | iHc | Hk/iHc | Br × | area |
| | components | (° C.) | (m) | (%) | (kG) | (kOe) | (%) | iHc | (%) |
| Example 8 | Nd_{10.5}Pr_{3.5}Fe_{77.2}Co_{2.5}Ga_{0.7}B_{5.6} | 700 | 0.5 | 3.3 | 13.20 | 19.61 | 92.8 | 259 | 16.8 |
| Example 9 | Nd_{10.5}Pr_{3.5}Fe_{77.2}Co_{2.5}Ga_{0.7}B_{5.6} | 700 | 1.0 | 51 | 13.55 | 19.99 | 93.0 | 271 | 9.2 |
| Example 10 | Nd_{10.5}Pr_{3.5}Fe_{77.2}Co_{2.5}Ga_{0.7}B_{5.6} | 700 | 1.5 | 76.7 | 13.70 | 19.97 | 94.0 | 274 | 6.2 |
| Example 11 | Nd_{10.5}Pr_{3.5}Fe_{77.2}Co_{2.5}Ga_{0.7}B_{5.6} | 700 | 2.5 | 99.7 | 13.96 | 19.98 | 95.3 | 279 | 3.1 |
| Example 12 | Nd_{10.5}Pr_{3.5}Fe_{77.2}Co_{2.5}Ga_{0.7}B_{5.6} | 700 | 5.0 | 100 | 13.94 | 19.94 | 95.0 | 278 | 2.4 |
| Example 13 | Nd_{10.5}Pr_{3.5}Fe_{77.2}Co_{2.5}Ga_{0.7}B_{5.6} | 700 | 0.5 | 4.1 | 13.30 | 19.58 | 92.8 | 260 | 16.0 |
| Example 14 | Nd_{10.5}Pr_{3.5}Fe_{77.2}Co_{2.5}Ga_{0.7}B_{5.6} | 750 | 1.0 | 77.8 | 13.68 | 19.93 | 94.6 | 273 | 5.8 |
| Example 15 | Nd_{10.5}Pr_{3.5}Fe_{77.2}Co_{2.5}Ga_{0.7}B_{5.6} | 750 | 1.5 | 92.9 | 14.04 | 19.82 | 94.5 | 278 | 3.7 |
| Example 16 | Nd_{10.5}Pr_{3.5}Fe_{77.2}Co_{2.5}Ga_{0.7}B_{5.6} | 750 | 2.5 | 99.6 | 14.09 | 19.65 | 94.1 | 277 | 1.7 |
| Example 17 | Nd_{10.5}Pr_{3.5}Fe_{77.2}Co_{2.5}Ga_{0.7}B_{5.6} | 750 | 5.0 | 100 | 14.10 | 19.36 | 93.5 | 273 | 0.9 |
| Example 18 | Nd_{10.5}Pr_{3.5}Fe_{77.2}Co_{2.5}Ga_{0.7}B_{5.6} | 800 | 0.5 | 4.8 | 13.35 | 19.62 | 92.9 | 262 | 14.1 |
| Example 19 | Nd_{10.5}Pr_{3.5}Fe_{77.2}Co_{2.5}Ga_{0.7}B_{5.6} | 800 | 1.0 | 99.7 | 13.62 | 20.00 | 93.5 | 272 | 2.6 |
| Example 20 | Nd_{10.5}Pr_{3.5}Fe_{77.2}Co_{2.5}Ga_{0.7}B_{5.6} | 800 | 1.5 | 98 | 13.94 | 19.55 | 94.4 | 273 | 1.2 |
| Example 21 | Nd_{10.5}Pr_{3.5}Fe_{77.2}Co_{2.5}Ga_{0.7}B_{5.6} | 800 | 2.5 | 99.9 | 14.00 | 19.40 | 93.4 | 272 | 0.4 |
| Example 22 | Nd_{10.5}Pr_{3.5}Fe_{77.2}Co_{2.5}Ga_{0.7}B_{5.6} | 800 | 5.0 | 100 | 13.85 | 19.02 | 92.5 | 263 | 0 |
| Comparative | Nd_{10.5}Pr_{3.5}Fe_{77.2}Co_{2.5}Ga_{0.7}B_{5.6} | — | — | 0 | 13.23 | 19.50 | 92.8 | 258 | 17.2 |
| Example 2 | | | | | | | | | |

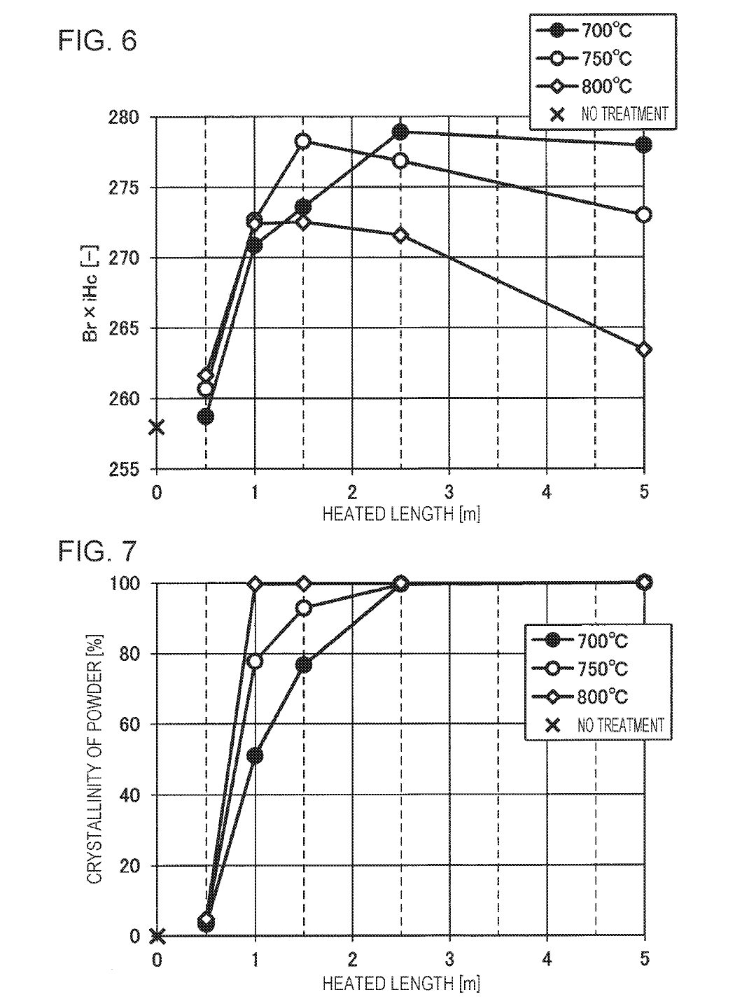

For the hot-deformed magnets of Comparative Example 2 and Examples 8 to 22 prepared as above, the powder crystallinity, the magnetic properties, and the coarse grain existing area were investigated by the same method as in “Experimental Example 1 (regarding the influence of the heating temperature)”. The results are indicated in Table 2. FIG. 6 illustrates the relationship between the heated length and the magnetic properties, and FIG. 7 illustrates the relationship between the heated length and the powder crystallinity.

As apparent from FIGS. 6 and 7, crystallization progressed and the magnetic properties improved when the heated length was 0.5 m or more.

### 3. Experimental Example 3 (Regarding the Influence of the Oxygen Concentration)

An alloy ribbon (Nd_{10.5}Pr_{3.5}Fe₇₇Co₃Ga_{0.4}B_{5.6}) prepared by a super quenching method using a rotating roll was roughly pulverized to prepare a raw material powder. Here, the powder grain size was changed during rough pulverization of the alloy ribbon so that raw material powders with different oxygen concentrations were obtained as illustrated in Table 3 (Comparative Examples 3 to 5). Each of these raw material powders was hot-formed at 650° C. by using a hot pressing machine until the density was near the true density, and the resulting hot-formed compact was uniaxially hot-plastic-worked at 700° C. until the reduction reached 70% so as to obtain hot-deformed magnets of Comparative Examples 3 to 5.

In contrast, hot-deformed magnets were prepared by subjecting each of the raw material powders respectively having the compositions of Comparative Examples 3 to 5 above to a rapid heat treatment using the falling-type heating furnace illustrated in FIG. 1B, and then performing the same hot forming and hot plastic working as in Comparative Examples 3 to 5 above on the raw material powder. In the rapid heat treatment, as indicated in Table 3, the atmosphere conditions inside the furnace (inside the metal pipe) of the falling-type heating furnace were changed so as to obtain raw material powders having different oxygen concentrations (Examples 23 to 27).

TABLE 3

| | | | | | | Oxygen | | | | |
|---|---|---|---|---|---|---|---|---|---|---|
| | | | | | | concentration | | | | |
| | | Rapid heat treatment conditions | | | | (wt %) | | Magnetic | | |
| | | Heating | | | In-fumace | Powder | | properties after | | |
| | | tem- | Heated | | oxygen | after | | hot deforming | | |
| | Raw material powder | perature | length | | concentration | rapid | After hot | Br | iHc | Br × |
| | components | (° C.) | (m) | Atmosphere | (ppm) | heating | deforming | (kG) | (kOe) | iHc |
| Example 23 | Nd_{10.5}Pr_{3.5}Fe₇₇Co₃Ga_{0.4}B_{5.6} | 700 | 5 | Injected simultaneously | 737 | 0.541 | 0.561 | 11.10 | 12.30 | 137 |
| | | | | with Ar flow | | | | | | |
| Example 24 | Nd_{10.5}Pr_{3.5}Fe₇₇Co₃Ga_{0.4}B_{5.6} | 700 | 5 | Injected 1 minute | 312 | 0.282 | 0.294 | 12.93 | 16.98 | 220 |
| | | | | after Ar flow | | | | | | |
| Example 25 | Nd_{10.5}Pr_{3.5}Fe₇₇Co₃Ga_{0.4}B_{5.6} | 700 | 5 | Injected 5 minutes | 209 | 0.214 | 0.220 | 13.06 | 18.38 | 240 |
| | | | | after Ar flow | | | | | | |
| Example 26 | Nd_{10.5}Pr_{3.5}Fe₇₇Co₃Ga_{0.4}B_{5.6} | 700 | 5 | Injected 10 minutes | 84 | 0.112 | 0.120 | 13.09 | 19.90 | 260 |
| | | | | after Ar flow | | | | | | |
| Example 27 | Nd_{10.5}Pr_{3.5}Fe₇₇Co₃Ga_{0.4}B_{5.6} | — | — | Ar flow after | 3 | 0.052 | 0.052 | 13.08 | 21.41 | 280 |
| | | | | vacuum substitution | | | | | | |
| Comparative | Nd_{10.5}Pr_{3.5}Fe₇₇Co₃Ga_{0.4}B_{5.6} | — | — | — | — | 0.173 | 0.175 | 12.56 | 16.91 | 212 |
| Example 3 | | | | | | | | | | |
| Comparative | Nd_{10.5}Pr_{3.5}Fe₇₇Co₃Ga_{0.4}B_{5.6} | — | — | — | — | 0.058 | 0.070 | 12.59 | 19.68 | 248 |
| Example 4 | | | | | | | | | | |
| Comparative | Nd_{10.5}Pr_{3.5}Fe₇₇Co₃Ga_{0.4}B_{5.6} | — | — | — | — | 0.044 | 0.050 | 12.55 | 20.26 | 254 |
| Example 5 | | | | | | | | | | |

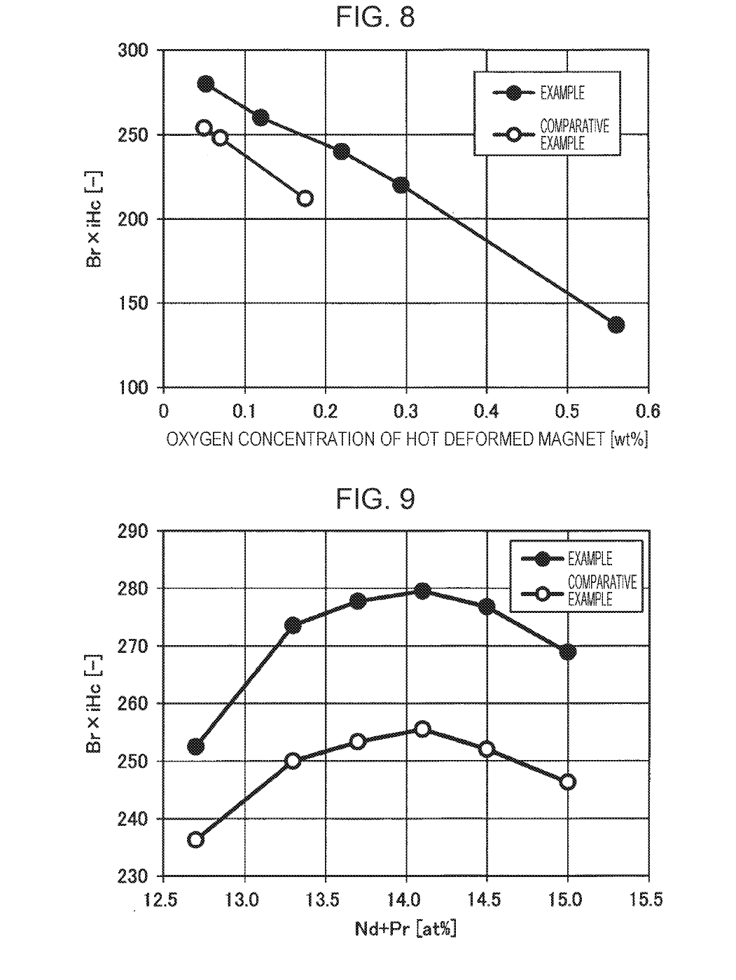

For the hot-deformed magnets of Comparative Examples 3 to 5 and Examples 23 to 27 prepared as above, the magnetic properties were investigated by the same method as in “Experimental Example 1 (regarding the influence of the heating temperature)”. In addition, for Comparative Examples 3 to 5 and Examples 23 to 27, the oxygen concentrations in the raw material powders after the rapid heating and in the compacts after the hot plastic working were investigated. The results are indicated in Table 3. FIG. 8 illustrates the relationship between the oxygen concentration in the compact after hot working (hot-deformed magnet) and the magnetic properties.

According to FIG. 8, compared to Comparative Examples 3 to 5, Examples 23 to 27 tend to exhibit superior magnetic properties at equal oxygen concentrations after hot working. However, it was found that, in Examples, the magnetic properties were poor compared to Comparative Examples when the oxygen concentration was increased to a certain value or more (0.3 wt % or more). Furthermore, Table 3 finds that the oxygen concentration inside the falling-type heating furnace during the rapid heating is preferably 300 ppm or less.

### 4. Experimental Example 4 (Regarding the Influence of the Components)

The alloys having compositions with various RE contents as in Examples 28 to 33 and Comparative Examples 6 to 11 indicated in Table 4 were prepared into alloy ribbons by a super quenching method using a rotating roll, and the alloy ribbons were roughly pulverized to prepare raw material powders. Each of the raw material powders of Comparative Examples 6 to 11 was hot-formed at 650° C. by using a hot pressing machine until the density was near the true density, and the resulting hot-formed compact was uniaxially hot-plastic-worked at 750° C. until the reduction reached 70% so as to obtain hot-deformed magnets of Comparative Examples 6 to 11.

In contrast, hot-deformed magnets of Examples 28 to 33 were prepared by subjecting the raw material powders of Examples 28 to 33 to a rapid heat treatment using the falling-type heating furnace illustrated in FIG. 1B under the rapid heat treatment conditions indicated in Table 4, and then performing the same hot forming and hot plastic working as in Comparative Examples 6 to 11 above on the resulting raw material powders.

TABLE 4

| | | | | | | | | Rapid heat treatment | | | | | | |
|---|---|---|---|---|---|---|---|---|---|---|---|---|---|---|
| | | | | | | | | conditions | | Magnetic properties after hot | | | | Coarse |
| | Constituent components | | | | | | | Heating | Heated | deforming | | | | grain |
| | RE | | | | | | | temperature | length | Br | iHc | Hk/iHc | Br × | area |
| | Nd | Pr | Nd + Pr | Fe | Co | Ga | B | (° C.) | (m) | (kG) | (kOe) | (%) | iHc | (%) |
| Example 28 | 9.6 | 3.1 | 12.7 | 78.7 | 2.5 | 0.5 | 5.6 | 700 | 5 | 14.80 | 17.06 | 97.5 | 252 | 0 |
| Example 29 | 10 | 3.3 | 13.3 | 78.1 | 2.5 | 0.5 | 5.6 | 700 | 5 | 14.02 | 19.51 | 95.4 | 274 | 0.6 |
| Example 30 | 10.3 | 3.4 | 13.7 | 77.7 | 2.5 | 0.5 | 5.6 | 700 | 5 | 13.61 | 20.41 | 93.8 | 278 | 1.5 |
| Example 31 | 10.5 | 3.6 | 14.1 | 77.3 | 2.5 | 0.5 | 5.6 | 700 | 5 | 13.23 | 21.13 | 93.1 | 280 | 2.4 |
| Example 32 | 10.9 | 3.6 | 14.5 | 76.9 | 2.5 | 0.5 | 5.6 | 700 | 5 | 12.57 | 22.02 | 92.3 | 277 | 3.3 |
| Example 33 | 11.3 | 3.7 | 15.0 | 76.4 | 2.5 | 0.5 | 5.6 | 700 | 5 | 11.92 | 22.56 | 90.5 | 269 | 4.0 |
| Comparative | 9.6 | 3.1 | 12.7 | 78.7 | 2.5 | 0.5 | 5.6 | — | — | 14.21 | 16.63 | 95.1 | 236 | 13.2 |
| Example 6 | | | | | | | | | | | | | | |
| Comparative | 10 | 3.3 | 13.3 | 78.1 | 2.5 | 0.5 | 5.6 | — | — | 13.18 | 18.97 | 92.1 | 250 | 14.4 |
| Example 7 | | | | | | | | | | | | | | |
| Comparative | 10.3 | 3.4 | 13.7 | 77.7 | 2.5 | 0.5 | 5.6 | — | — | 13.06 | 19.40 | 89.9 | 253 | 15.8 |
| Example 8 | | | | | | | | | | | | | | |
| Comparative | 10.5 | 3.6 | 14.1 | 77.3 | 2.5 | 0.5 | 5.6 | — | — | 12.41 | 20.59 | 89.1 | 256 | 17.2 |
| Example 9 | | | | | | | | | | | | | | |
| Comparative | 10.9 | 3.6 | 14.5 | 76.9 | 2.5 | 0.5 | 5.6 | — | — | 11.68 | 21.58 | 88.0 | 252 | 18.7 |
| Example 10 | | | | | | | | | | | | | | |
| Comparative | 11.3 | 3.7 | 15.0 | 78.9 | 2.5 | 0.5 | 5.6 | — | — | 11.17 | 22.05 | 87.2 | 246 | 20.0 |
| Example 11 | | | | | | | | | | | | | | |

For the hot-deformed magnets of Comparative Examples 28 to 33 and Comparative Examples 6 to 11 prepared as above, the magnetic properties and the coarse grain existing area were investigated by the same method as in “Experimental Example 1 (regarding the influence of the heating temperature)”. The results are indicated in Table 4. FIG. 9 illustrates the relationship between the RE content and the magnetic properties.

According to FIG. 9, compared to Comparative Examples 6 to 11, Examples 28 to 33 tend to exhibit superior magnetic properties at any RE content.

The present disclosure is applicable to permanent magnets used in motors and the like.

What is claimed is:

1. A method for producing a raw material powder for a hot-deformed magnet, the method comprising steps of:
(i) preparing an alloy powder in an amorphous structure state or an amorphous-microcrystalline mixed structure state, the step (i) comprising quenching and solidifying a melt of an alloy containing a rare earth element (RE), Fe, and B as main components by a super quenching method using a rotating roll; and
(ii) subjecting the alloy powder to a rapid heat treatment in a falling-type heating furnace so as to obtain a raw material powder.

2. The method for producing a raw material powder for a hot-deformed magnet according to claim 1, wherein:
conditions for the rapid heat treatment in the falling-type heating furnace include that:
a temperature elevation rate is 400° C./minute or more,
a heating temperature is equal to or higher than a crystallization onset temperature of the alloy powder and is 600° C. to 800° C., and
an atmosphere inside the falling-type heating furnace is a vacuum or an inert atmosphere; and
the rapid heat treatment is performed at least once under these conditions.

3. The method for producing a raw material powder for a hot-deformed magnet according to claim 1, wherein a heating zone of the falling-type heating furnace has a length of 0.5 m or more, and a furnace core into which the alloy powder falls extends substantially in a vertical direction or is slanted within 5° with respect to the vertical direction.

4. The method for producing a raw material powder for a hot-deformed magnet according to claim 1, wherein 50% or more of the raw material powder after the rapid heat treatment is crystallized, and an oxygen concentration of the raw material powder or an oxygen concentration of a hot-deformed magnet produced by using the raw material powder is 3000 ppm or less.

5. The method for producing a raw material powder for a hot-deformed magnet according to claim 1, wherein the alloy containing the rare earth element (RE), Fe, and B as main components is represented by a compositional formula, REₓ(Fe, Co)₁₀₀₋ₓB_{y}M_{z}, where:
RE represents a rare earth element that contains 90 atom % or more of one or both of Pr and Nd, and 0 atom % or more and 10 atom % or less of at least one element selected from Y and lanthanoid series elements other than Pr and Nd,
M represents at least one element selected from the group consisting of Al, Si, Ti, V, Cr, Mn, Ni, Cu, Ga, Zr, Nb, Mo, Hf, Ta, W, Pt, Pb, Au, and Ag, and
compositional ratios x, y, and z satisfy 12≤x≤16, 4≤y≤7, and 0.01≤z≤5.

6. A method for producing a hot-deformed magnet, comprising:
subjecting the raw material powder obtained by the method according to claim 1 to hot-forming to densify the raw material powder to substantially true density so as to form a hot-formed compact; and
subjecting the hot-formed compact to uniaxial hot plastic working to orient crystals.

7. A hot-deformed magnet produced by the method according to claim 6.

8. The hot-deformed magnet according to claim 7,
wherein coarse crystal grains having a crystal grain size of 0.5 m or more are present at an area ratio of 10% or less.

9. The hot-deformed magnet according to claim 7, wherein Dy or Tb is not contained, and a product of a residual magnetic flux density (kG) and a coercive force (kOe) is 250 or more.

10. The method for producing a raw material powder for a hot-deformed magnet according to claim 1, wherein the step (i) comprises quenching and solidifying the melt of the alloy on a surface of the rotating roll to produce a strip of solidified alloy and pulverizing the strip.

11. The method for producing a raw material powder for a hot-deformed magnet according to claim 1, wherein the step (ii) comprises heating the alloy powder while the alloy powder falls down by free fall inside the heating furnace.

12. The method for producing a raw material powder for a hot-deformed magnet according to claim 4, wherein the raw material powder has 50% or more of degree of crystallinity.
